(19) United States
(12) Patent Application Publication
(10) Pub. No.: US 2001/0020825 A1
(43) Pub. Date: Sep. 13, 2001

(54) Starting device for discharge lamp

(76) Inventors: Osamu Miyata, Tokyo (JP); Hisao Hirata, Fujisawa-shi (JP)

Correspondence Address: Douglas W. Sprinkle, Gifford, Krass, Sprikle, Anderson & Citkowski, P.C., 280 N. Old Woodward, Suite 400, Brimingham, MI, 48009, US

(21) Appl. No.: 09/778,512

(22) Filed: Feb. 7, 2001

(30) Foreign Application Priority Data
Mar. 10, 2000 (JP) 2000-066436

(51) Int. Cl. H01K 1/62; H01J 7/44

(52) U.S. Cl. 315/57; 315/240

(57) ABSTRACT

One of the objectives of the present invention are to provide smaller, lighter and less expensive structure in a starting device for discharge lamp for car use so as to prevent breakage due to vibrations etc. And another objective is to obtain the high efficient device having a reduced conductor loss. A starting device for discharge lamp comprising; a socket equipped with a high voltage electrode and a grounding electrode for mounting the discharge lamp and a starting parts equipped with a starting transformer, which has a bobbin, a core having a through hole a primary and secondary coils wound around the bobbin where a high voltage leading wire of the secondary coil is connected to a high voltage terminal of the socket via the through hole of the core.

### BACKGROUND OF THE INVENTION

1. Field of the Invention

The present invention relates to a starting device for discharge lamp, particularly suitable to a lamp lighting device for vehicle headlights.

2. Brief Description of the Prior Art

The lamp lighting device for vehicle headlights usually consists of the following components: a discharge lamp, a socket for mounting the discharge lamp equipped with a high voltage electrode and a starting transformer equipped with a bobbin for winding a primary and a secondary coils. The starting transformer equipped with a core has been widely used in the conventional lamp lighting device. FIG. 7A and FIG. 7B show examples of structures (with cores 91 without through holes) in conventional starting transformers. FIG. 7A illustrates manners how all leading wires (i.e. a leading wire 36 at a high voltage side of a secondary coil 32, a leading wire 37 at a low voltage side of the secondary coil 32 and two leading wires 38 from a primary coil 33), are led out from a surface of a cast molding material 40. Since the leading wire 36 from lowermost section of a bobbin 31 runs through near the primary coil 33 (the primary coil 33 is wound around the upper most section of the secondary coil 32), the molding material 40 should be formed so as to have at least 2 to 3 mm thickness for having an enough insulation distance. Which requires not only an enclosing case 92 with larger diameter but also insulation of wiring between the leading wire 36 to the high voltage electrode 22 (See FIG. 1A, FIG. 2A FIG. 3 and FIGS. 6A, 6C) arranged in the center of the socket. In order to ensure these insulation, more molding material are required, consequently, a larger and heavier transformer is required. FIG. 7B shows another example where the leading wire 37 at a low voltage side and two leading wires 38 are led out from the bottom of the enclosing case 92. In this case holes for leading these leading wires should be sealed by adhesives etc. to prevent the molding material from leaking out, which results in more man-hours. In this example due to insulating wiring from these leading wires to the high voltage electrode, the same drawbacks (larger and heavier transformer) are inevitable.

As mentioned above, due to the core at the center of the conventional starting transformer and due to the wiring extending from leading wires to the high voltage electrode equipped in the center of the socket, a conducting loss, namely, decreased efficiency, is inevitably brought, as well as heavier and larger structure is required in order to ensure enough insulation of the wiring.

### SUMMARY OF THE INVENTION

The present invention is carried out in view of the above-mentioned problems so as to provide a small sized and light weighed device free from breakage due to vibrations and impacts. Also it provides a starting device for discharge lamp with good weight balanced main body having more efficiency with less conductor loss.

The starting device for discharge lamp is constituted as follows:

(1) The starting device for discharge lamp comprising; a socket equipped with a high voltage electrode and a grounding electrode for mounting the discharge lamp and a starting component which consists a starting transformer equipped with a bobbin, a primary, a secondary coils wound around the bobbin and a core having a through hole; where a high voltage leading wire of the secondary coil is connected to a high voltage terminal of the socket via the through hole of the core.

(2) The starting device for discharge lamp according to (1), the core of the starting transformer is formed as a cylindrical structure out of ferrite or dust core materiel and the bobbin is formed as a cylindrical and divided winding structure where; an outer diameter of the core is set 2 to 20 mm, a diameter and a length of the through hole of the core are set 0.1 to 10 mm and 2 to 20 mm respectively, and the core is arranged at a rear side of the socket on the same axis of the socket.

(3) The starting device for discharge lamp according to (1) where the device is equipped with a harness with connector.

(4) The starting device for discharge lamp according to (1) where the device is equipped with a direct coupler.

### BRIEF DESCRIPTION OF DRAWINGS

FIGS. 1A and 1B show a constitution of a first embodiment according to the present invention.

FIG. 1A is a front view.

FIG. 1B is a side view.

FIG. 2A is a cross sectional view along A-A line in FIG. 1A.

FIG. 2B is a rear view of the embodiment with a rear socket cover removed.

FIG. 3 is an enlarged view of the main portion of FIG. 2A.

FIG. 4 shows a starting circuit diagram of the present invention.

FIGS. 5A to 5D show winding manners in primary and secondary coils. FIGS. 5A to 5D show a first, a second, a third and a fourth methods respectively.

FIGS. 6A to 6D show a constitution of a second embodiment according to the present invention.

FIG. 6A is a front view.

FIG. 6B is a side view.

FIG. 6C is a cross sectional view along B-B line in FIG. 6A.

FIG. 6D is a rear view with a rear socket case removed, where a direct coupler is equipped.

FIGS. 7A and 7B show constitutions of conventional starting transformers.

### DETAILED DESCRIPTION OF THE PREFERRED EMBODIMENTS

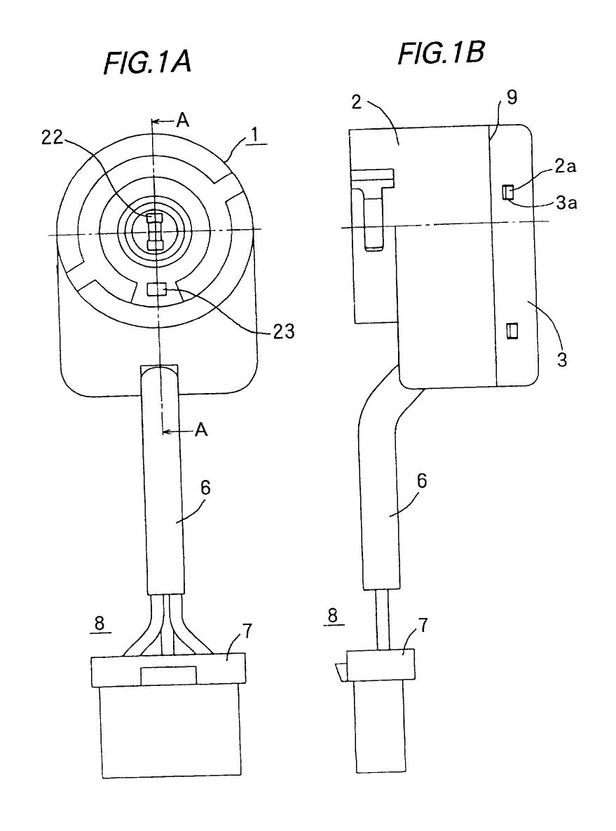

Hereinafter detailed description of embodiments according to the present invention is explained by referring FIG. 1 to FIGS. 6A to 6D.

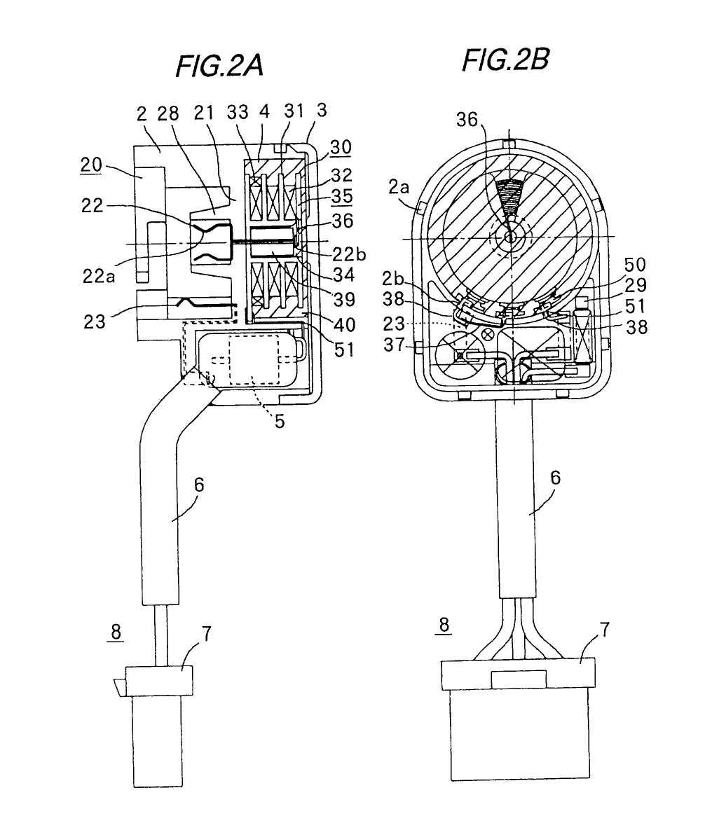

The first embodiment according to the present invention shown in FIGS. 1A, 1B and FIGS. 2A, 2B is explained. This embodiment relates to a starting device for lamp lighting equipped in a lamp lighting device for an HID lamp. The lamp lighting device includes power sources for the HID lamp and for a trigger element to generate a starting pulse etc. equipped in a main body (not shown) of the lamp lighting device. The starting device for lamp lighting consists structural members such as parts for starting and an HID lamp socket etc. The main body of the lamp lighting device and the starting device for lamp lighting is electrically connected between a connector 7 equipped to the starting device for lamp lighting via a harness 6 and a direct coupler equipped to the main body of the lightning device.

FIG. 1A is a front view of a starting device 1 for lamp lighting for car use where a front socket case 2, a left side portion of a parting line 9 (see FIG. 1B), has a high voltage electrode 22 and a GND (grounding) electrode 23 formed by an insert molding or a direct insertion. FIG. 1B is a side view illustrating how 7 protruded portions 2a (quantity varies case by case) formed on the socket case 2 are fitted in cutout openings 3a formed on a rear socket case 3.

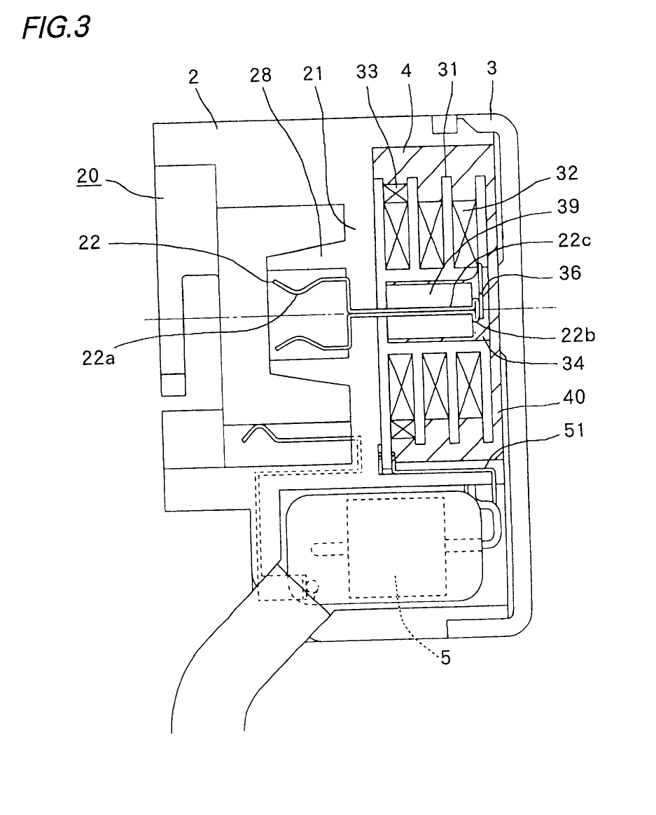

Hereinafter an inside arrangement of a socket 20 constituted in the above-mentioned way is explained by referring FIG. 2A, a cross sectional view of along A-A line in FIG. 1A, FIG. 2B, a rear view with a socket case 3 removed and FIG. 3, an enlarged view of FIG. 2A. An insulating wall 28 is formed in the socket for insulating between the high voltage electrode 22 and the GND electrode 23, since a voltage between them reaches up to 20-odd kV. A high voltage leading electrode 22c (see FIG. 3) led out from a high voltage lamp mounting electrodes 22a of the high voltage electrode 22 surrounded by the insulating wall 28, comprises a rear portion of the high voltage electrode 22. The high voltage leading electrode 22c has a circular cross sectional area with diameter of 0.1 to 10 mm or a corresponding square cross sectional area with diameter of 0.1 to 8 mm square, so as to withstand the maximum current 2.6 A for the HID lamp. The high voltage leading electrode 22c extends thorough a separating wall 21 of the socket to a starting transformer accommodating space 4. The starting transformer 30 has a hollow space 34 where a core 39 (out of Ni-ferrite or dust core material) having a through hole (0.1 to 10 mm in diameter and 2 to 20 mm long) is inserted. The one end of the high voltage leading electrode 22c extending through the through hole of the core 39 is pressed into flat so as to form a high voltage electrode 22b at a starting transformer side. The core 39 with the through hole is fixed to the hollow space 34 by adhesives etc. A leading wire 36 at a high voltage side of a secondary coil 32 (which is explained below) is connected to the high voltage electrode 22b at the starting transformer side.

The starting transformer 30 consists of the bobbin 31 (having a circular cross section; Winding portions are divided into 3 to 6 sections.), the secondary coil 32 evenly wound around each winding section or more turns at a low voltage side than a high voltage side (not shown. Insulating property is improved by gradated turns.) and a primary coil wound around the secondary coil.

On the bobbin 31 a wire with a circular cross section is wound rather than a wire with a rectangular cross section considering a winding efficiency. (The wire with the circular section has the lowest copper loss when a cross sectional area and the number of the turn are kept constant due to the fact that the outer diameter of the wire, namely, a length of the wound wire amounts to the shortest.) A width of each divided section of the bobbin 31 is set several (an integer) times of the outer diameter (0.5˜5.0 mm) of the wire so as to attain the most efficient winding. A wall thickness between the sections is set 0.5 to 20 mm.

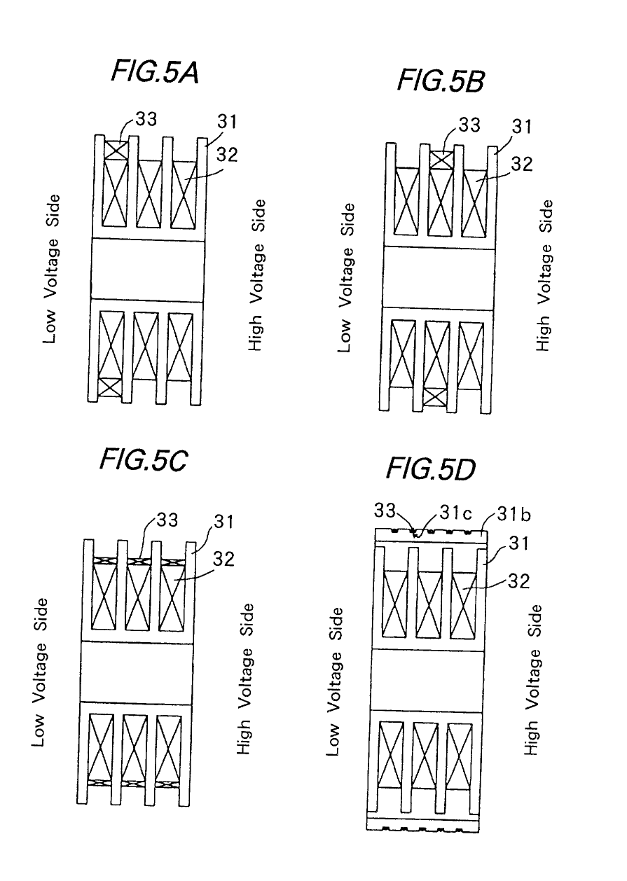

The primary coil 33 is arranged at the low voltage section of the secondary coil 32 (See FIG. 5A) considering a voltage difference between the primary and secondary coils. However, when a wire with high insulating property (withstand voltage: 10 to 20 kV) such as a wire with three layered insulation is used for the primary coil 33, the wire should be wound in a central area of the bobbin 31 where a connection between the primary and the secondary coils is most preferable. (See FIG. 5B.) Alternatively, sections in the bobbin 31 with evenly wound coil (See FIG. 5C) can be employed when good connection is attained.

The another alternative shown in FIG. 5D is constituted as follows: A bobbin case 31b is used as an insulating wall for preventing a leakage between the primary and secondary coils. On the primary coil a wire with a circular or rectangular cross-section is uniformly and sparsely wound around the outer diameter of the bobbin case 31b. Alternatively the wire is wound densely on the center section of the bobbin case 31b. On the bobbin case a groove 31c is formed spirally on the outer surface of the bobbin case 31b so as to ensure firm winding of the coil.

A leading wire 37 at a lower voltage side (see FIG. 2B) of the secondary coil 32 and two leading wires 38 of the primary coil 33 are connected to three leading wire connecting points 50 (number is adjustable) formed on the bobbin 31. And these leading wires are led to parts accommodating compartment 5 for the starting device via three slits 2b so as to trail on the side wall of a starting transformer accommodating compartment 4. Parts for a starting circuit accommodated in the parts accommodating compartment 5 for the starting device are connected to a connecting board 29 (see FIG. 2B) connected to the starting transformer and a harness assembly 8, by welding or high temperature soldering. Since this portion is located near the HID lamp so that the ambient temperature reaches ca. 150° C., a low temperature solder usually employed in organic circuit boards is not suitable.

The leading wires 37 and 38 are closely contacted with the starting transformer accommodating compartment 4 via a clip 51 in order to avoid these leading wires from contacting the coil 35 (particularly the secondary coil 32, to ensure insulation).

After accommodating the starting transformer 30 in the accommodating compartment 4, only the starting transformer 30 is molded with a molding material. (an epoxy resin, a urethane resin, a silicon resin and the like). The insulation is easily attained by the molding material 40 which is flown into the core 39 and its through hole. In some cases the parts accommodating compartment 5 for starting device is molded after arranging parts for the starting circuit in it for ensuring insulation, protection against humidity and vibration and a stable fixture of parts.

The GND electrode 23 is connected to the parts accommodating compartment 5 for the starting device via inner portion of a separating wall 21 of the socket (see FIG. 2A), and finally it is connected to the harness assembly 8, which leads to the main body of the starting apparatus via the inputting connector 7.

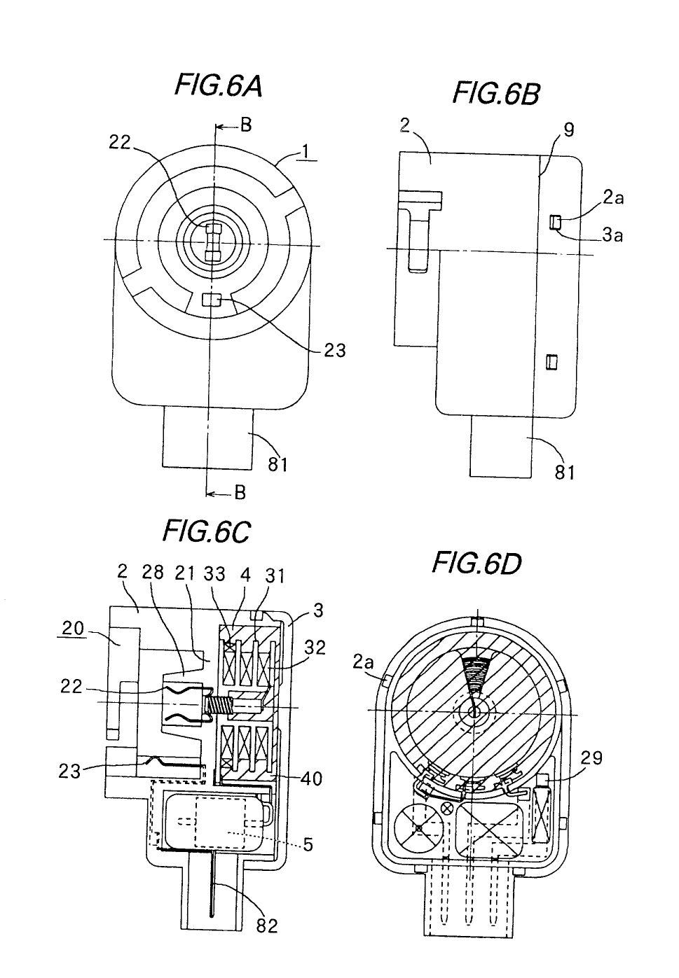

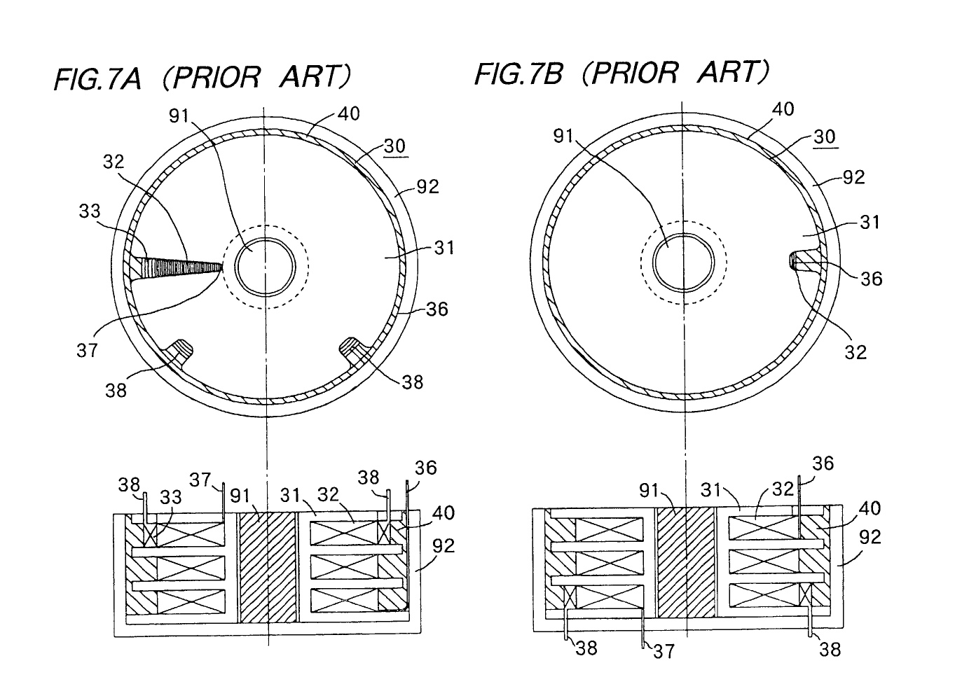

Hereinafter the second embodiment shown in FIGS. 6A to 6D is explained. An electrical connection between the main body of the starting device and starting device for lamp lighting is attained by connecting a direct coupler equipped on the main body of the starting device to a direct coupler 81 equipped on the starting device for lamp lighting, via a harness having a connector (not shown).

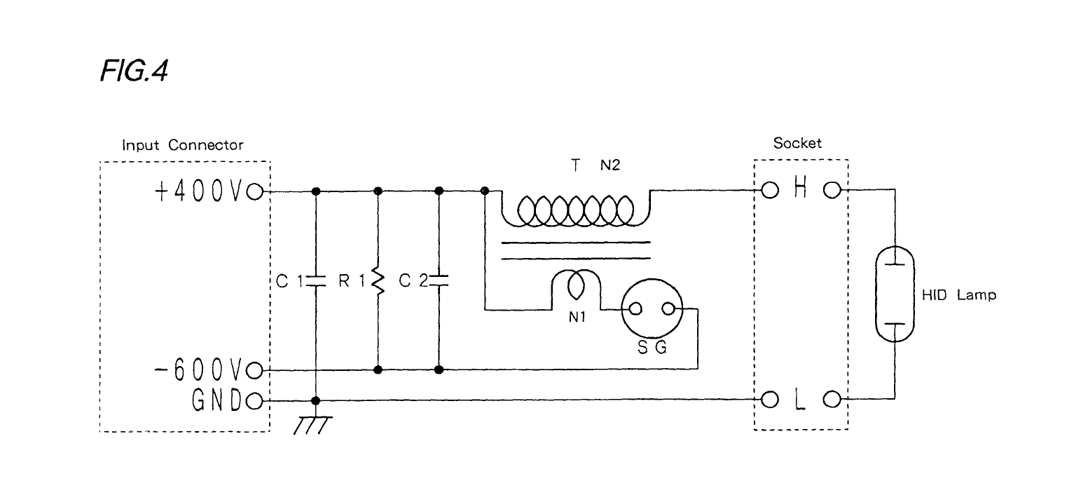

Input terminals 82 (3 terminals +400V, −600V and GND in FIG. 4) equipped in the direct coupler 81 are metal electrodes formed in one-pieced member (formed in the socket case 2 or 3 by an insert molding) combined with a HID-GND electrode and an electrode 23 at a low voltage side of the secondary coil 32 or formed in separated members. Since only this forming method of the metal electrodes is different from that of the preceding embodiment 1, further detailed explanation is omitted.

Hereinafter a starting lamp circuit depicted in FIG. 4 is described. Input powers supplied from the main body of the starting device (not shown in the figure) are +400V, GND as main powers and −600V as a power for SG (spark gap), a trigger element for high voltage pulse. In these embodiments the SG having a break down point of 800 kV is selected among SGs for car use having the break down points between 400V and 3 kV. The power −600V is supplied to the starting device circuit via resistance (not shown) connected in series to the output terminal. A constant determining a pulse cycle (usually between 30 to 150 Hz) is determined by applying 1 kV (voltage between the two terminals −600V and 400V) to a circuit where the above-mentioned resistance (not shown) and a charging/discharging capacitor C2 are connected in series.

When a voltage in the capacitor C2 reaches the break down point (In case of the SG of 800V the value is 800V +/−15%.) a electric current starts to flow in a primary coil N1 of the starting transformer T, which induces a high voltage in a secondary coil N2. The induced high voltage generates a starting pulse (ca. 25 kV) at the power +400V, as a result the HID lamp is activated. In the figure C1 is a capacitor used as a filter for the input powers and R1 is a resistance for discharging electric charge stored in the capacitor C2.

According to the present invention, following advantages are attained by the device arranged the core structure having the through hole and the electrical connection between the leading wire at high voltage side of the secondary coil and the high voltage electrode led through the through hole of the core having the through hole. (a) A higher insulating property between the transformer and its periphery is attained. (b) A smaller and lighter device is obtained. (c) Breakage of the device caused by vibrations and impacts etc. is prevented by arranging the starting transformer on the same central axis of the socket. (d) The device having the less conductor loss with high efficiency and a good weight balance is obtained by forming the bobbin of the transformer having the round cross section. (e) The device can be fitted to every type of cars by attaining various connecting methods between the main body of the lamp lighting device and the starting device for lamp lighting.

In other words the following effects are attained in each component of the device.

(1) Core Having the Through Hole

The through hole at the center of the core enables the socket case and the coil to be aligned on the same center axis. Which results in an easy connection between the output leading wire on high voltage side of the coil and the socket terminal arranged on the opposite side by wiring the high voltage leading wire via the through hole of the core. And less conductor loss is attained by the good insulating property and the shortest wiring distance.

(2) Alignment of the Starting Transformer at the Center of the Socket

Since the transformer, the heaviest component in the device, is arranged at the center of the HID lamp, namely at the center of the socket, the good weight-balanced device with more compact sized device is obtained.

(3) Connection Between the Main Body of the Device and Lamp Lighting Device

By employing the harness equipped with the connector, coupler (connector) portion of the harness is formed more compact than the direct coupler method. In some direct coupler methods, since a length of the harness equipped with the connector is adjustable to desired length, it is easily applied to different types of cars.

What is claimed is:

1. A starting device for a discharge lamp comprising; a socket equipped with a high voltage electrode and a grounding electrode for mounting said discharge lamp and a starting component which consists a starting transformer equipped with a bobbin, a primary, a secondary coils wound around said bobbin and a core having a through hole; where a high voltage leading wire of said secondary coil is connected to a high voltage terminal of said socket via said through hole of said core.

2. The starting device for discharge lamp according to claim 1 said core of said starting transformer is formed as a cylindrical structure out of ferrite or dust core materiel and said bobbin is formed as a cylindrical and a divided winding structure where; an outer diameter of said core is set 2 to 20 mm, a diameter and a length of said through hole of said core are set 0.1 to 10 mm and 2 to 20 mm respectively, and said core is arranged at a rear side of said socket on the same axis of said socket.

3. The starting device for the discharge lamp according to claim 1, wherein a harness with connector is arranged.

4. The starting device for the discharge lamp according to claim 1, wherein a direct coupler is arranged.
